(19) United States
(12) Patent Application Publication
(10) Pub. No.: US 2025/0074219 A1
(43) Pub. Date: Mar. 6, 2025

(54) RESOURCE ALLOCATION IN A MULTIPLE VEHICLE SYSTEM

(71) Applicants: Hyundai Motor Company, Seoul (KR); Kia Corporation, Seoul (KR)

(72) Inventors: Ernestine Fu, Somerville, MA (US); John Suh, Palo Alto, CA (US); Alec Taraborrelli, Superior Township, MI (US)

(21) Appl. No.: 18/238,955

(22) Filed: Aug. 28, 2023

(51) Int. Cl. B60L 53/126

(52) U.S. Cl. CPC B60L 53/126

(57) ABSTRACT

A multiple vehicle system is provided. The multiple vehicle system may comprise a land-based vehicle configured to traverse over ground, an aerial vehicle configured to travel through air, and a power system comprising a plurality of power components, wherein the plurality of power components are distributed across the land-based vehicle and the aerial vehicle. The aerial vehicle may be configured to detachably couple with the land-based vehicle.

### BACKGROUND

### Technical Field

Embodiments of the present disclosure relate to multiple vehicle systems and systems and methods for allocating resources of multiple vehicle systems.

### Background

In general, vehicles are relatively limited in their modes of movement. For example, aerial vehicles, such as, e.g., airplanes and drones, are able to travel through the air from location to location, but are generally very limited or incapable of ground-based movement. Similarly, ground-based vehicles, such as automobiles, are generally limited to travel on roads or, on occasion, off-road travel that is accessible via roads and/or ground-based travel.

It is often necessary to provide ground vehicular access to difficult-to-access locations. For example, remote regions of wilderness may lack access via roads. While a land-based vehicle may be desired at a particular location, it may be difficult or impossible to provide such a land-based vehicle to the location due to the lack of ground access. Moreover, even if a ground location is accessible via roads or ground transport, it may be difficult or impossible to reach a desired location in a timely manner due to the remoteness of the location.

In other circumstances, it may be difficult for a ground vehicle to reach a desired destination due to a current situation on the ground. For example, a natural disaster such as, e.g., a forest fire, or a weather condition such as, e.g., freshly laid ice or snow, may limit ground access to the desired destination. Military conflicts and/or geopolitical incidents may also limit ground access to the desired destination.

### SUMMARY

According to an object of the present disclosure, a multiple vehicle system is provided. The multiple vehicle system may comprise a land-based vehicle configured to traverse over ground, an aerial vehicle configured to travel through air, and a power system comprising a plurality of power components, wherein the plurality of power components are distributed across the land-based vehicle and the aerial vehicle. The aerial vehicle may be configured to detachably couple with the land-based vehicle.

According to an exemplary embodiment, the land-based vehicle and the aerial vehicle may be electrically coupled via an electrical connection.

According to an exemplary embodiment, the electrical connection may comprise a wireless connection.

According to an exemplary embodiment, the electrical connection may be configured to provide power transmission between the land-based vehicle and the aerial vehicle.

According to an exemplary embodiment, the plurality of power components may comprise one or more batteries, and the power transmission may be configured to charge a battery of the plurality of power components.

According to an exemplary embodiment, the power transmission may be configured to transmit power from the aerial vehicle to a battery of the land-based vehicle.

According to an exemplary embodiment, the power transmission may be configured to transmit power from the land-based vehicle to a battery of the aerial vehicle.

According to an exemplary embodiment, at least one power component of the plurality of power components may be configured to be detachably transferrable between the land-based vehicle and the aerial vehicle.

According to an exemplary embodiment, the plurality of power components may be configured to be utilized in series at one of the land-based vehicle and the aerial vehicle.

According to an exemplary embodiment, the plurality of power components may be configured to be utilized in parallel at one of the land-based vehicle and the aerial vehicle.

According to an object of the present disclosure, a system is provided. The system may comprise a multiple vehicle system comprising a land-based vehicle configured to traverse over ground, an aerial vehicle configured to travel through air, and a power system comprising a plurality of power components, wherein the plurality of power components are distributed across the land-based vehicle and the aerial vehicle. The aerial vehicle may be configured to detachably couple with the land-based vehicle. The system may further comprise a computing device, comprising a processor and a memory, configured to store programming instructions. The programming instructions, when executed by the processor, may be configured to cause the processor to cause the aerial vehicle to detach from the land-based vehicle.

According to an exemplary embodiment, the land-based vehicle and the aerial vehicle may be electrically coupled via an electrical connection.

According to an exemplary embodiment, the electrical connection may comprise a wireless connection.

According to an exemplary embodiment, the electrical connection may be configured to provide power transmission between the land-based vehicle and the aerial vehicle.

According to an exemplary embodiment, the plurality of power components may comprise one or more batteries, and the power transmission may be configured to charge a battery of the plurality of power components.

According to an exemplary embodiment, the power transmission may be configured to transmit power from the aerial vehicle to a battery of the land-based vehicle.

According to an exemplary embodiment, the power transmission may be configured to transmit power from the land-based vehicle to a battery of the aerial vehicle.

According to an exemplary embodiment, at least one power component of the plurality of power components may be configured to be detachably transferrable between the land-based vehicle and the aerial vehicle.

According to an exemplary embodiment, the plurality of power components may be configured to be utilized in series at one of the land-based vehicle and the aerial vehicle.

According to an exemplary embodiment, the plurality of power components may be configured to be utilized in parallel at one of the land-based vehicle and the aerial vehicle.

### BRIEF DESCRIPTION OF THE DRAWINGS

The accompanying drawings, which are incorporated in and form a part of the Detailed Description, illustrate various non-limiting and non-exhaustive embodiments of the subject matter and, together with the Detailed Description, serve to explain principles of the subject matter discussed below. Unless specifically noted, the drawings referred to in this Brief Description of Drawings should be understood as not being drawn to scale and like reference numerals refer to like parts throughout the various figures unless otherwise specified.

FIG. 1 illustrates a combination multiple vehicle system comprising an aerial vehicle and a land-based vehicle, according to an exemplary embodiment of the present disclosure.

FIG. 2 illustrates an aerial vehicle of the combination multiple vehicle system, according to an exemplary embodiment of the present disclosure.

FIG. 3 illustrates a land-based vehicle of the combination multiple vehicle system, according to an exemplary embodiment of the present disclosure.

FIGS. 4A and 4B are diagrams illustrating a leg-wheel component in retracted and extended positions, according to some exemplary embodiments.

FIG. 4C is a diagram illustrating the low range of motion suspension stage and the high range of motion suspension stage, according to an exemplary embodiment.

FIG. 5 illustrates a combination multiple vehicle system comprising an aerial vehicle and a land-based vehicle, according to an exemplary embodiment of the present disclosure.

FIG. 6 illustrates a block diagram of an example power system comprising power components that are detachably transferrable between two vehicles of a multiple vehicle system, according to an exemplary embodiment of the present disclosure.

FIG. 7 illustrates a use case of a combination multiple vehicle system comprising an aerial vehicle conveying a land-based vehicle to a destination, according to an exemplary embodiment of the present disclosure.

FIG. 8 illustrates a use case of a land-based acting as a mobile charging station, according to an exemplary embodiment of the present disclosure.

FIG. 9 illustrates a use case of a combination multiple vehicle system comprising a land-based vehicle having a cargo pod, according to an exemplary embodiment of the present disclosure.

FIG. 10 illustrates a use case of a combination multiple vehicle system comprising an aerial vehicle surveying terrain and communicating information about the terrain to a land-based vehicle, according to an exemplary embodiment of the present disclosure.

FIG. 11 illustrates a use case of a combination multiple vehicle system comprising an aerial vehicle and a land-based vehicle operating in combination to provide long-distance communication, according to an exemplary embodiment of the present disclosure.

FIG. 12 illustrates example elements of a computing device, according to an exemplary embodiment of the present disclosure.

FIG. 13 illustrates an example architecture of a vehicle, according to an exemplary embodiment of the present disclosure.

### DETAILED DESCRIPTION

The following Detailed Description is merely provided by way of example and not of limitation. Furthermore, there is no intention to be bound by any expressed or implied theory presented in the preceding background or in the following Detailed Description.

Reference will now be made in detail to various exemplary embodiments of the subject matter, examples of which are illustrated in the accompanying drawings. While various embodiments are discussed herein, it will be understood that they are not intended to limit to these embodiments. On the contrary, the presented embodiments are intended to cover alternatives, modifications, and equivalents, which may be included within the spirit and scope of the various embodiments as defined by the appended claims. Furthermore, in this Detailed Description, numerous specific details are set forth in order to provide a thorough understanding of embodiments of the present subject matter. However, embodiments may be practiced without these specific details. In other instances, well known methods, procedures, components, and circuits have not been described in detail as not to unnecessarily obscure aspects of the described embodiments.

Some portions of the detailed descriptions which follow are presented in terms of procedures, logic blocks, processing, and other symbolic representations of operations on data within an electrical device. These descriptions and representations are the means used by those skilled in the data processing arts to most effectively convey the substance of their work to others skilled in the art. In the present application, a procedure, logic block, process, or the like, is conceived to be one or more self-consistent procedures or instructions leading to a desired result. The procedures are those requiring physical manipulations of physical quantities. Usually, although not necessarily, these quantities may take the form of electrical or magnetic signals capable of being stored, transferred, combined, compared, and otherwise manipulated in an electronic system, device, and/or component.

It should be borne in mind, however, that these and similar terms are to be associated with the appropriate physical quantities and are merely convenient labels applied to these quantities. Unless specifically stated otherwise as apparent from the following discussions, it is appreciated that throughout the description of embodiments, discussions utilizing terms such as “determining,” “communicating,” “taking,” “comparing,” “monitoring,” “calibrating,” “estimating,” “initiating,” “providing,” “receiving,” “controlling,” “transmitting,” “isolating,” “generating,” “aligning,” “synchronizing,” “identifying,” “maintaining,” “displaying,” “switching,” or the like, refer to the actions and processes of an electronic item such as: a processor, a sensor processing unit (SPU), a processor of a sensor processing unit, an application processor of an electronic device/system, or the like, or a combination thereof. The item manipulates and transforms data represented as physical (electronic and/or magnetic) quantities within the registers and memories into other data similarly represented as physical quantities within memories or registers or other such information storage, transmission, processing, or display components.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles. In aspects, a vehicle may comprise an internal combustion engine system as disclosed herein.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. These terms are merely intended to distinguish one component from another component, and the terms do not limit the nature, sequence or order of the constituent components. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules and the processor is specifically configured to execute said modules to perform one or more processes which are described further below.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

Embodiments described herein may be discussed in the general context of processor-executable instructions residing on some form of non-transitory processor-readable medium, such as program modules, executed by one or more computers or other devices. Generally, program modules include routines, programs, objects, components, data structures, etc., that perform particular tasks or implement particular abstract data types. The functionality of the program modules may be combined or distributed as desired in various embodiments.

In the figures, a single block may be described as performing a function or functions; however, in actual practice, the function or functions performed by that block may be performed in a single component or across multiple components, and/or may be performed using hardware, using software, or using a combination of hardware and software. To clearly illustrate this interchangeability of hardware and software, various illustrative components, blocks, modules, logic, circuits, and steps have been described generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Also, the example device vibration sensing system and/or electronic device described herein may include components other than those shown, including well-known components.

Various techniques described herein may be implemented in hardware, software, firmware, or any combination thereof, unless specifically described as being implemented in a specific manner. Any features described as modules or components may also be implemented together in an integrated logic device or separately as discrete but interoperable logic devices. If implemented in software, the techniques may be realized at least in part by a non-transitory processor-readable storage medium comprising instructions that, when executed, perform one or more of the methods described herein. The non-transitory processor-readable data storage medium may form part of a computer program product, which may include packaging materials.

The non-transitory processor-readable storage medium may comprise random access memory (RAM) such as synchronous dynamic random access memory (SDRAM), read only memory (ROM), non-volatile random access memory (NVRAM), electrically erasable programmable read-only memory (EEPROM), FLASH memory, other known storage media, and the like. The techniques additionally, or alternatively, may be realized at least in part by a processor-readable communication medium that carries or communicates code in the form of instructions or data structures and that can be accessed, read, and/or executed by a computer or other processor.

Various embodiments described herein may be executed by one or more processors, such as one or more motion processing units (MPUs), sensor processing units (SPUs), host processor(s) or core(s) thereof, digital signal processors (DSPs), general purpose microprocessors, application specific integrated circuits (ASICs), application specific instruction set processors (ASIPs), field programmable gate arrays (FPGAs), a programmable logic controller (PLC), a complex programmable logic device (CPLD), a discrete gate or transistor logic, discrete hardware components, or any combination thereof designed to perform the functions described herein, or other equivalent integrated or discrete logic circuitry. The term “processor,” as used herein may refer to any of the foregoing structures or any other structure suitable for implementation of the techniques described herein. As employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Moreover, processors can exploit nano-scale architectures such as, but not limited to, molecular and quantum-dot based transistors, switches and gates, in order to optimize space usage or enhance performance of user equipment. A processor may also be implemented as a combination of computing processing units.

In addition, in some aspects, the functionality described herein may be provided within dedicated software modules or hardware modules configured as described herein. Also, the techniques could be fully implemented in one or more circuits or logic elements. A general purpose processor may be a microprocessor, but in the alternative, the processor may be any processor, controller, microcontroller, or state machine. A processor may also be implemented as a combination of computing devices, e.g., a combination of an SPU/MPU and a microprocessor, a plurality of microprocessors, one or more microprocessors in conjunction with an SPU core, MPU core, or any other such configuration. One or more components of an SPU or electronic device described herein may be embodied in the form of one or more of a “chip,” a “package,” an Integrated Circuit (IC).

According to an exemplary embodiment of the present disclosure, a combination multiple vehicle system is provided. The combination multiple vehicle system may comprise an aerial vehicle and a land-based vehicle, in accordance with exemplary embodiments of the present disclosure. The constituent vehicles of the combination multiple vehicle system may be configured for cooperative transport, such that the aerial vehicle may be configured to convey the land-based vehicle during aerial travel for delivery to a desired location. In accordance with an exemplary embodiment, the aerial vehicle and the land-based vehicle may be operable to provide cooperative and/or symbiotic operations.

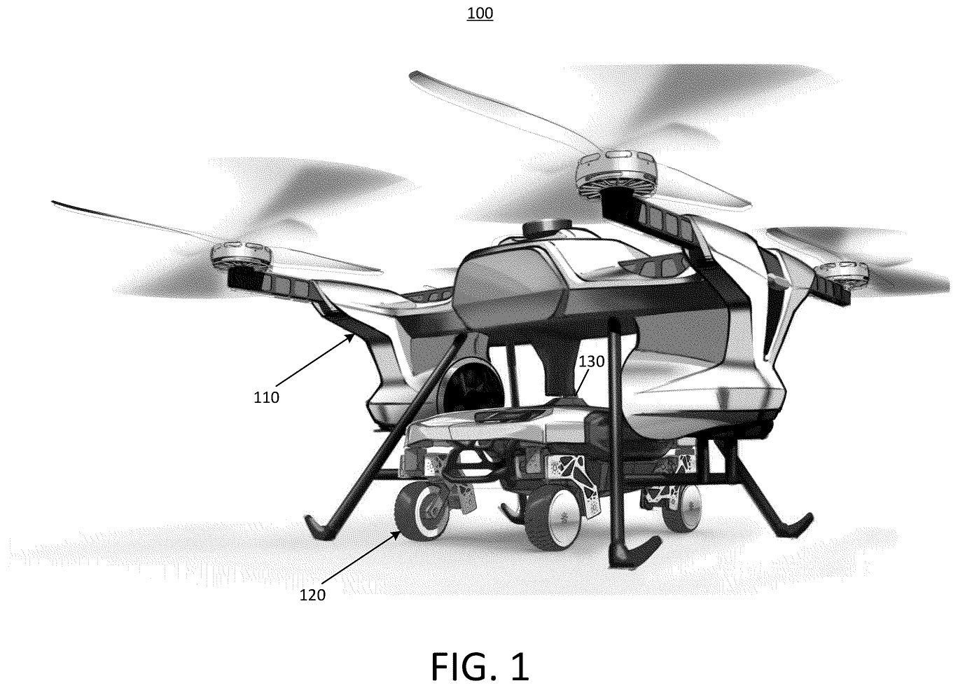

Referring now to FIG. 1, a combination multiple vehicle system 100 is illustratively depicted, in accordance with an exemplary embodiment of the present disclosure.

The combination multiple vehicle system 100 may comprise an aerial vehicle 110 and a land-based vehicle 120, according to some exemplary embodiments. According to an exemplary embodiment, the aerial vehicle 110 may be configured to removably couple to the land-based vehicle 120 for conveyance of the land-based vehicle 120 from a first location to a second location for land-based operation. According to an exemplary embodiment, the combination multiple vehicle system 100 may be configured to leverage the speed and efficiency of air travel, using the aerial vehicle 120, with the value of land-based operations, using the land-based vehicle 120.

According to an exemplary embodiment, the aerial vehicle 110 may be configured to convey the land-based vehicle 120 to an otherwise inaccessible and/or difficult-to-access location, due to, e.g., limits on ground access or travel time. For example, the destination may be located in a remote region without access via roads, or the destination may be far enough away such that ground access would not be possible for timely conveyance of the land-based vehicle 120. In other examples, the destination may be difficult to access on the ground due to current conditions, such as, e.g., natural disasters, weather conditions, military conflict zones, and/or other forms of civil unrest, etc. According to an exemplary embodiment, the combination multiple vehicle system 100 may be configured to be capable of delivering the land-based vehicle 120 for ground operations using the aerial vehicle 110.

It should be appreciated that various design considerations and optimizations are taken into account when designing the combination multiple vehicle system 100 based on potential use cases. For example, since the aerial vehicle 110 may be configured to convey a land-based vehicle 120 through the air to a destination, and potentially to convey additional cargo of the land-based vehicle 120, the land-based vehicle 120 may, according to some exemplary embodiments, may configured to be as light and strong as possible for the potential use cases.

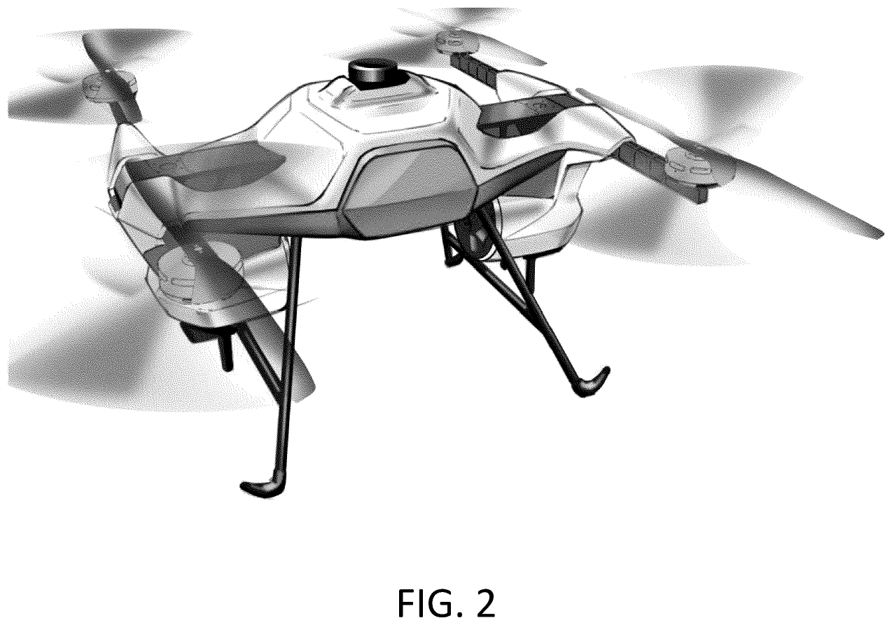

Referring now to FIG. 2, an example aerial vehicle 110 of the combination multiple vehicle system 100 is illustratively depicted, in accordance with an exemplary embodiment of the present disclosure.

According to an exemplary embodiment, the aerial vehicle 110 in FIG. 2 is illustrated as a drone. However, it should be appreciated that the aerial vehicle 110 may be any suitable type of airborne vehicle capable of air travel, including, without limitation, a drone, an airplane, a helicopter, a hovercraft, and/or other self-propelling airborne vehicles.

According to an exemplary embodiment, the aerial vehicle 110 may be configured to be capable of remote operation, autonomous operation, and/or a combination of remote and autonomous operation. For example, the aerial vehicle 110 may be configured such that a user may be able to remotely control operation of the aerial vehicle 110, such as, e.g., from a command center. In other examples, the aerial vehicle 110 may be configured to operate autonomously, such that a destination is provided and the aerial vehicle 110 is capable of self-navigating to the destination.

According to an exemplary embodiment, the aerial vehicle 110 may be powered using combustion power sources, electrical power sources, and/or hybrid power comprising a combination of combustion and electrical power sources. According to an exemplary embodiment, using hybrid power, the combustion component of the hybrid power source may be configured to charge a battery of the electrical power source during operation. According to an exemplary embodiment, the hybrid power source may also be used as a charging station for a battery/power cell of the land-based vehicle 120, either during air travel or on the ground, when the land-based vehicle 120 is coupled to the aerial vehicle 110.

According to an exemplary embodiment, the aerial vehicle 110 may be configured to provide the charging capability to the land-based vehicle 120 via an electrical connection. It should be appreciated that the electrical connection for providing power may comprise a wired connection and/or a wireless connection (e.g., connection-free). According to an exemplary embodiment, the land-based vehicle 120 may be a hybrid electric/combustion powered vehicle. It should be appreciated that combustion power sources for the aerial vehicle 110 and/or the land-based vehicle 120 may comprise an internal combustion engine, a hydrogen fuel cell, and/or another propulsion means other than an electric motor.

According to an exemplary embodiment, the power system of the combination multiple vehicle system 100 may be designed and configured such that connection-free (e.g., wireless) charging may be used between the aerial vehicle 110 and the land-based vehicle 120 to transfer energy to one or more power storage devices (e.g., batteries) of each vehicle 110, 120. For example, the wireless charging may comprise inductive charging between separate coils of each device. According to an exemplary embodiment, one or more vehicle control systems may be configured to determine the relative allocation of energy between the two vehicles 110, 120 based on the intended mission.

According to an exemplary embodiment, the power system of the combination multiple vehicle system 100 may comprise a battery system having one or more power components that may be utilized be each of the two vehicles 110, 120 and may be detachably transferrable between the two vehicles 110, 120. These power components, such as, e.g., power cells or battery units, may be transferred between the two vehicles 110, 120, depending on the use case. For example, the power components may be aligned within each vehicle 110, 120 in certain power allocation modes such as, e.g., an in-series mode or a parallel mode. For instance, the in-series mode may be configured to provide extended range to the vehicle (e.g., the aerial vehicle 110 and the land-based vehicle 120) and the parallel mode may be configured to provide maximum power to the vehicle (e.g., the aerial vehicle 110 and the land-based vehicle 120). According to an exemplary embodiment, the one or more vehicle control systems may be configured to determine the power allocation mode of the vehicle or vehicles (e.g., the aerial vehicle 110 and the land-based vehicle 120).

According to an exemplary embodiment, the combination multiple vehicle system 100 may comprise one or more other (non)-redundant components configured to facilitate additional use cases and expanded operations, where (non)-redundant refers to a particular component or system that may intentionally be duplicated in the two vehicles 110, 120 to provide a back-up source, or that a single instance of a component or system is used in one vehicle only. For example, a long-range communication system may be placed in the aerial vehicle 110 to expand a communication range. In another example, one or more energy-intensive tools, such as, e.g., digging tools or drilling tools, with larger energy needs may be placed in the land-based vehicle 120. According to an exemplary embodiment, one or more components and/or systems of the combination multiple vehicle system 100 may be subject to (non)-redundant treatment. In addition to power systems, communication systems, actuated tools, sensing capabilities, and/or computing capabilities may also be subject to (non)-redundant system allocation. For example, data may be gathered by one or more sensors by one vehicle, but subject to computation on the second vehicle (or even a remote, third platform).

According to an exemplary embodiment, multiple aerial vehicles 110 and/or land-based vehicles 120 may be configured to operate as a combination multiple vehicle system 100 such that some or any of the aerial vehicles 110 may be configured to operate cooperatively with some or any of the land-based vehicles 110, thereby expanding the operability of different use cases. For example, a plurality of aerial vehicles 110 may be configured to deliver a plurality of land-based vehicles 120 to a location. Once the plurality of land-based vehicles 120 are deployed, one aerial vehicle 110 may be deployed to provide long range communications while another aerial vehicle 110 that is deployed to map the environment. Another aerial vehicle 110 may be deployed as a ground power/charging station for the land-based vehicles 120 or other land-based operations. According to the use case, any aerial vehicle 110 may operate cooperatively with any land-based vehicle 120, according to an exemplary embodiment.

According to an exemplary embodiment, the aerial vehicle 110 may be configured to be capable of performing short takeoffs and landings. According to an exemplary embodiment, the aerial vehicle 110 may be configured to be capable of performing substantially vertical takeoffs and landings, but this may be difficult in certain situation. According to an exemplary embodiment, the aerial vehicle 110 may be configured to be capable of hovering at a substantially steady position during operation (e.g., when the aerial vehicle 110 is a drone).

According to an exemplary embodiment, the aerial vehicle 110 may comprise a connection mechanism 130 for detachably coupling to the land-based vehicle 120. According to an exemplary embodiment, the aerial vehicle 110 may be configured to engage the connection mechanism 130 with the land-based vehicle 120 by approaching the land-based vehicle 120 vertically and/or laterally from one direction.

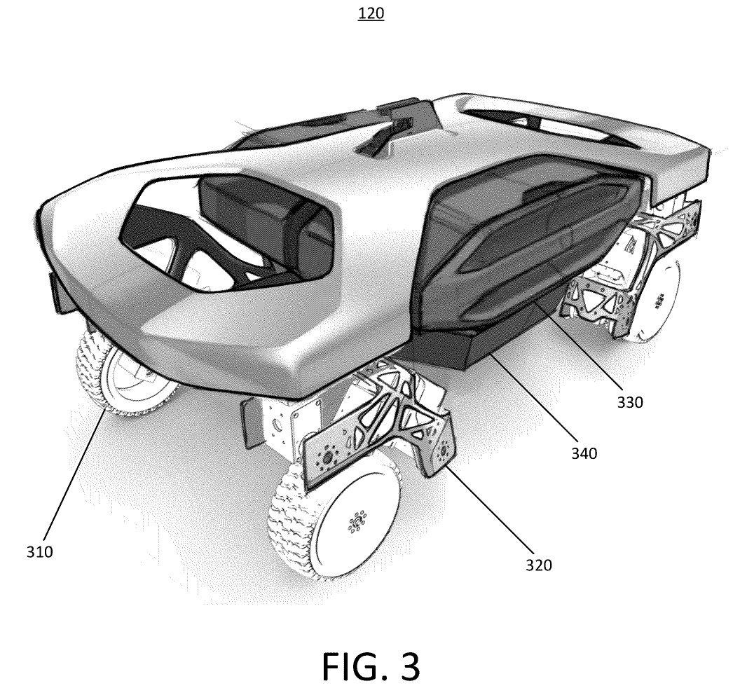

Referring now to FIG. 3, a land-based vehicle 120 of the combination multiple vehicle system 100 is illustratively depicted, in accordance with an exemplary embodiment of the present disclosure.

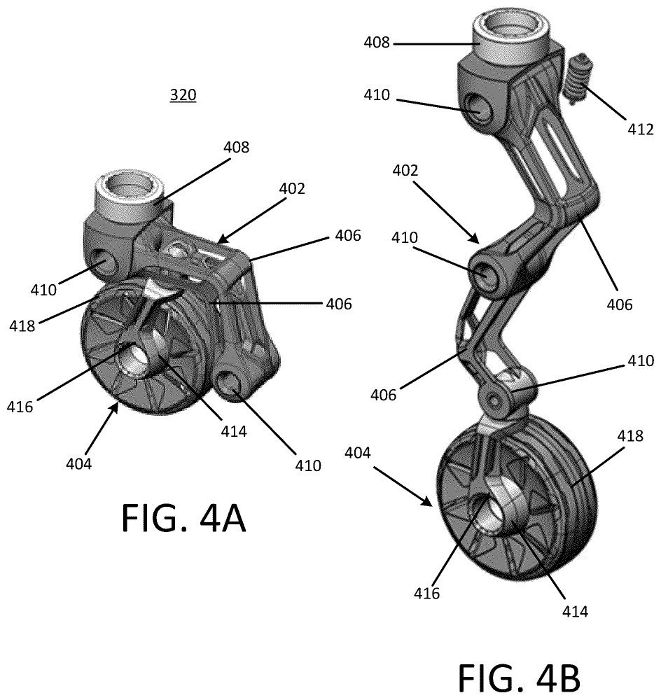

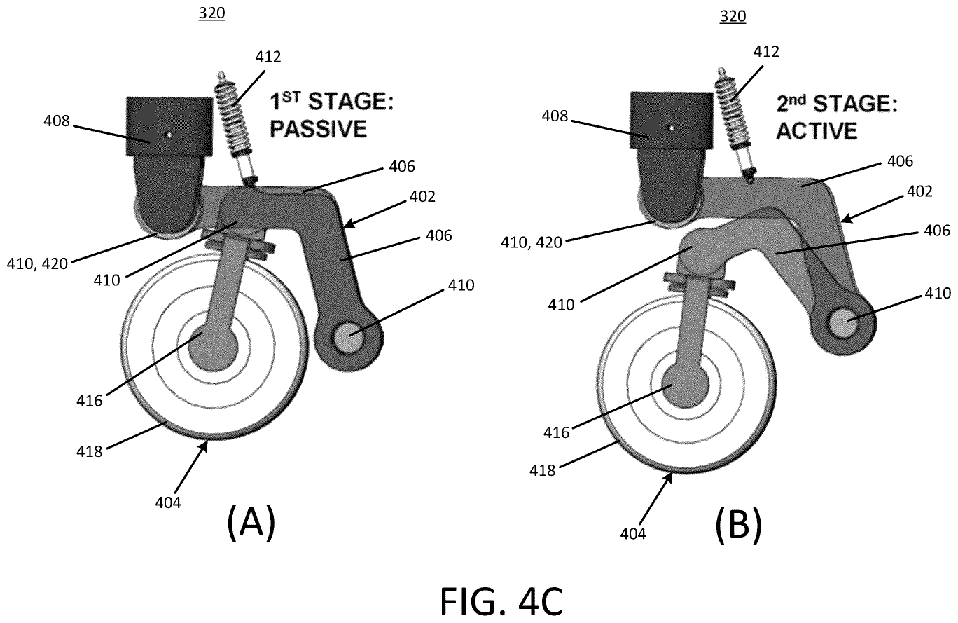

According to an exemplary embodiment, the land-based vehicle 120 may be configured to be capable of wheel-based travel using one or more wheels 310 and and/or walking travel using one or more nesting leg units 320 (as shown, e.g., in FIGS. 4A-4C). While the land-based vehicle 120 is illustrated as having wheels 310 and nesting leg units 320, it should be appreciated that the land-based vehicle 120 may be any suitable type of vehicle capable of and configured to perform ground travel, including, without limitation, an automobile, a continuous track vehicle, etc.

According to an exemplary embodiment, the land-based vehicle 120 may be configured to be capable of navigating extreme and rugged terrain that is typically unnavigable for conventional automobiles or off-road vehicles. For example, the nesting leg units 320 may be configured to be capable of providing walking travel for the land-based vehicle 120. According to an exemplary embodiment, in designing the land-based vehicle 120 and nesting leg units 320 (or any other mechanism for providing walking travel), four metrics of motion capabilities should be considered: a height of any step onto which the land-based vehicle 120 may need to climb; a steepness of any angle which the land-based vehicle 120 may need to traverse; a height and/or width (e.g., depth) of an obstacle over which the land-based vehicle 120 may need to traverse; and a width (e.g., depth) of any gap which the land-based vehicle 120 may need to step over.

As will be appreciated by those of ordinary skill in the art, these metrics are considerations for designing the ground traversal abilities of the land-based vehicle 120, and may be dependent or based on potential locations for usage of the land-based vehicle 120. For example, these four metrics may be different for different climates and terrains, as well as urban or wilderness terrains. It is noted that other metrics for designing the land-based vehicle 120 may be considered and/or incorporated, according to an exemplary embodiment of the present disclosure. For example, as the land-based vehicle 120 is designed for use in different extreme environments, the land-based vehicle 120 may be designed to withstand environments of both hot and cold temperatures, should be able to withstand rain and water damage, and should be able to traverse different types of ground (e.g., sand, snow, ice, brush, water, etc.). According to an exemplary embodiment, the land-based vehicle 120 may be used on a surface of the moon or other planets, such as, e.g., Mars, and should be designed according to those environments.

According to an exemplary embodiment, the land-based vehicle 120 may be configured to be capable of remote operation, autonomous operation, and/or a combination of remote and autonomous operation. For example, the land-based vehicle 120 may be configured to be operated by remote control such that a user may be able to remotely control operation of the land-based vehicle 120 such as, e.g., from a command center. According to an exemplary embodiment, the land-based vehicle 120 may be configured to operate autonomously, such that a destination may be provided and the land-based vehicle 120 may be configured to be capable of self-navigating to the destination.

According to an exemplary embodiment, the land-based vehicle 120 may comprise one or more cargo pods 330. The one or more cargo pods 330 may be configured to detach from the chassis 340 of the land-based vehicle 120. According to an exemplary embodiment, the one or more cargo pods 330 may be configured to be removed from the land-based vehicle 120 and/or may be configured to be retrieved by the aerial vehicle 110.

Referring now to FIGS. 4A and 4B, an example leg-wheel component 320 in a retracted position (FIG. 4A) and an extended position (FIG. 4B), are illustratively depicted, in accordance with an exemplary embodiment of the present disclosure.

Various exemplary embodiments of nesting leg units 320 are described in co-pending U.S. patent application Ser. No. 16/743,310 (U.S. Patent Application Publication No. 2020/0216127). It is noted that other configurations of one or more leg-wheel components 102 may be incorporated into the present disclosure, while maintaining the spirit and functionality of the present disclosure.

The leg-wheel component 320 may comprise a leg component 402 and a wheel component 404. The wheel component 404 may be coupled to the leg component 402.

According to an exemplary embodiment, the leg-wheel component 320 may comprise a coupling component 408 configured to couple the leg-wheel component 320 to the body, chassis 340, frame, and/or other suitable component of a hybrid vehicle (e.g., the land-based vehicle 120 and/or the land-based vehicle 120 of the combined multiple vehicle system 100).

According to an exemplary embodiment, the leg component 402 may be divided into one or more segments 406. The one or more segments 406, coupling component 408, and/or the wheel component 404 may be configured to rotate about each other via one or more movable joint components 410. According to an exemplary embodiment, the leg-wheel component 320 may comprise one or more suspension systems 412 (e.g., springs, shock absorbers, etc.).

According to an exemplary embodiment, the wheel component 404 may be configured to rotate along an axis while coupled to the leg component 402, enabling the hybrid vehicle to move along a surface in contact with the wheel component 404. According to an exemplary embodiment, the leg-wheel component 320 may comprise one or more braking mechanisms for preventing and/or decreasing rotation of the wheel component 404.

With reference to FIG. 4A, the leg-wheel component 320 is in a retracted state, with the leg-wheel component 320 being configured and positioned to provide wheeled locomotion. With reference to FIG. 4B, the leg-wheel component 320 is in an extended state, with the leg-wheel component 230 being configured and positioned to provide walking locomotion.

According to an exemplary embodiment, wheeled locomotion may be available for use in situations where traditional vehicle travel using rolling wheels 404 is available (e.g., roads and highways). Wheeled locomotion is efficient, when available, for conveyance of a vehicle (e.g., the land-based vehicle 120 and/or the land-based vehicle 120 of the combined multiple vehicle system 100) between destinations. According to some exemplary embodiments, the leg-wheel components 320 may be configured to allow for active height adjustment of the hybrid vehicle, enabling the hybrid vehicle to go, e.g., from street use to off-road use.

In walking locomotion, the hybrid vehicle may be configured to walk up elevations and terrain that is not surmountable using wheeled locomotion. In some instances, walking locomotion allows for nimble and quiet motion, relative to wheeled locomotion. The hybrid vehicle may also be configured to move laterally, allowing for quadrupedal ambulation. According to an exemplary embodiment, the leg-wheel components 320 may be configured to provide a springing action and/or a jumping action to propel the hybrid vehicle away from a traversal surface.

According to an exemplary embodiment, the leg-wheel components 320 may comprise one or more in-wheel motors 414 configured to power movement of the wheel component 404 and/or the leg component 402. The use of in-wheel motors 414 frees the suspension 412 from traditional axles and allows ambulation, but also increases the driving performance and adaptability.

By using the wheels 404 as feet, the electric motors 414 may be configured to lock for stable ambulation, but also have slow torque controlled rotation for micro movements when climbing or during self-recovery. According to some exemplary embodiments, the wheel 204 of the leg-wheel component 320 may be configured to rotate 180 degrees perpendicular to a hub 416, not only allowing leaning capability while driving, but also giving the wheels 404 enhanced positioning potential when a tire 418 is locked and in a walking mode. The wheel 404 may be configured to turn 90 degrees and even may be configured to be used as a wide foot pad, lowering the hybrid vehicle's pounds per square inch (PSI) footprint when walking over loose materials or fragile surfaces, similar to that of a snowshoe.

Referring now to FIG. 4C, a diagram indicating a low range of motion suspension stage ((A), a passive stage), and a high range of motion suspension stage ((B), an active stage), of a leg-wheel component 320 is illustratively depicted, in accordance with an exemplary embodiment of the present disclosure.

According to an exemplary embodiment, the leg-wheel component 320 (also referred to herein as a “hybrid vehicle traversal component” or the “leg-wheel component”) may be configured to provide two stage suspension: a first, low range of motion suspension stage, when the leg-wheel component 320 is in a retracted position (A), and a second, high range of motion suspension stage, when the leg-wheel component 320 is in an extended position (B).

According to an exemplary embodiment, in the low range of motion suspension stage, a suspension system 412 (e.g., a coil-over suspension) may be utilized and engaged when the leg-wheel component 320 is in a retracted position. According to an exemplary embodiment, while in the low range of motion suspension state, a knee joint component 420 of the leg-wheel component 320 may be relaxed, while the remaining joints 410 of the leg-wheel component 320 may be locked. During the low range of motion suspension stage, the leg-wheel component 230 may be configured to handle high-frequency vibrations through the chassis-mounted suspension system 412. According to an exemplary embodiment, when the leg-wheel component 320 is retracted and the low range of motion suspension stage is enabled, the hybrid vehicle (e.g., the land-based vehicle 120 and/or the land-based vehicle 120 of the combined multiple vehicle system 100) may be configured to provide 0 to 5 inches of suspension during wheeled locomotion. It is noted, however, that other amounts of suspension may be incorporated while maintaining the spirit and functionality of the present disclosure.

According to an exemplary embodiment, in the high range of motion suspension stage, the suspension system 412 (e.g., the coil-over suspension) may be disengaged when the leg-wheel component 320 is in an extended or actuated position. For example, the suspension system 412 may be configured to remain with the chassis 340 during the high range of motion suspension stage, and the knee joint 420 may be driven by a motor to provide suspension. According to an exemplary embodiment, during the high range of motion suspension stage, the leg-wheel component 320 may be configured to support advanced driving dynamics through the capabilities of a motor at the knee joint 420. According to an exemplary embodiment, when the leg-wheel component 320 is extended and the high range of motion suspension stage is enabled, the hybrid vehicle (e.g., the land-based vehicle 120 and/or the land-based vehicle 120 of the combined multiple vehicle system 100) may be configured to provide 5 to 50 inches of suspension during walking locomotion. It is noted, however, that other amounts of suspension may be incorporated while maintaining the spirit and functionality of the present disclosure.

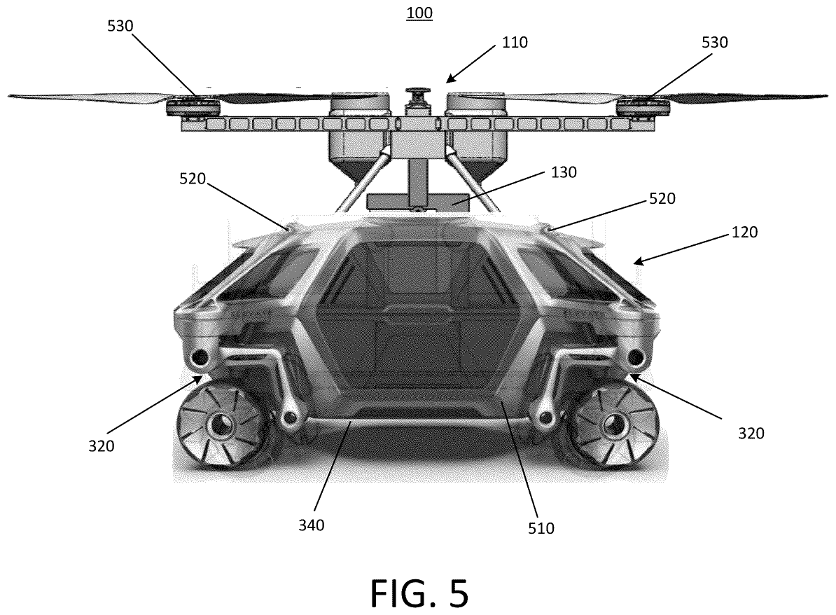

Referring now to FIG. 5, a diagram of a combined multiple vehicle system 100 is illustratively depicted, in accordance with an exemplary embodiment of the present disclosure.

According to an exemplary embodiment, the aerial vehicle 110 may comprise a connection mechanism 130 for detachably coupling the aerial vehicle 110 to the land-based vehicle 120. According to an exemplary embodiment, the aerial vehicle 110 may be configured to engage the connection mechanism 130 with the land-based vehicle 120 by approaching the land-based vehicle 120 vertically and/or laterally from one direction. For example, the aerial vehicle 110 may be configured to vertically approach the land-based vehicle 120 such that the connection mechanism 130 may be configured to engage with a bolt or pin of the land-based vehicle 120. This example is useful in vertical takeoffs and landings. In another example, the aerial vehicle 110 may be configured to laterally approach the land-based vehicle 120 (e.g., parallel to the ground) such that the connection mechanism 130 engages with a bolt or pin of the land-based vehicle 120. This example is useful in short takeoffs and landings. It should be appreciated that various different types of connection mechanisms and/or methods of the aerial vehicle 110 approaching the land-based vehicle 120 are contemplated and may be used in accordance with the described embodiments.

According to an exemplary embodiment, the aerial vehicle 110 may be configured to removably couple to the land-based vehicle 120 for conveyance of the land-based vehicle 120 from a first location to a second location. According to an exemplary embodiment, the aerial vehicle 110 may be configured to provide additional propulsion to the land-based vehicle 120 during an enhanced performance mode. The land-based vehicle 120 and the aerial vehicle 110 may be configured to leverage the efficiency of land-based travel to a launching point, where the aerial vehicle 110 may be configured to release from the land-based vehicle 120 and perform one or more air-based operations. It should be appreciated that the land-based vehicle 120 may comprise and/or be configured to transport one or more aerial vehicles 110. According to an exemplary embodiment, the land-based vehicle 120 may be configured to carry human passengers. According to an exemplary embodiment, the hybrid vehicle 200 may comprise a passenger compartment 510 configured to receive one or more human passengers.

In accordance with various embodiments, the aerial vehicle 110 may be configured to operate to provide a third propulsion system to the land-based vehicle 120 (with wheeled locomotion and walking locomotion being the other two propulsion systems) for providing lift to the land-based vehicle 120 to assist in vehicular mobility during an enhanced performance mode of the combined multiple vehicle system 100. During the enhanced performance mode, the propulsion of the aerial vehicle 110 may be synchronized with at least one of the wheeled and/or walking locomotion systems, to improve mobility of the land-based vehicle 120 to overcome obstacles or untraversable terrain. It should be appreciated that, in some exemplary embodiments, the aerial vehicle 110 may be a permanent structure of the combined multiple vehicle system 100, e.g., one or more rotor systems 530 may be affixed to the top of the land-based vehicle 120.

According to an exemplary embodiment, the combined multiple vehicle system 100 may be configured to perform autonomous navigation, such that the aerial vehicle 110 and/or the land-based vehicle 120 may be configured to navigate without human control. According to an exemplary embodiment, the land-based vehicle 120 and/or the aerial vehicle 110 may be configured to be controlled by a human operator, either onboard or remote to the combined multiple vehicle system 100. It should be appreciated that any combination of autonomous and remote control may be used to control the land-based vehicle 120, the aerial vehicle 110, and/or the combined multiple vehicle system 100 as a whole. For example, the combined multiple vehicle system 100 may be configured to operate autonomously until a destination is reached and/or an obstacle is encountered, at which point a human operator may take control. According to an exemplary embodiment, the land-based vehicle 120 and/or the aerial vehicle 110 may comprise one or more cameras 520 configured to capture one or more images in order for a position of the land-based vehicle 120 and/or the aerial vehicle 110 to be displayed to a human operator.

According to an exemplary embodiment, the aerial vehicle 110 may comprise a hoist and cable for lowering and raising the connection mechanism 130. For example, deployment and/or recovery of the land-based vehicle 120 may be in a location where the aerial vehicle 110 is unable to land (e.g., areas with dense trees or heavy winds). According to an exemplary embodiment, the aerial vehicle 110 may be configured to hover over the destination and deploy and/or recover the land-based vehicle 120 by lowering and raising the connection mechanism 130 using, e.g., the hoist and cable. According to an exemplary embodiment, the connection mechanism 130 may be configured to be released (for deployment) and/or engaged (for retrieval) when the land-based vehicle 120 is on the ground. Another example of a use for the hoist and cable deployment and retrieval may be in uses in caves, pit, or other similar areas that are inaccessible by ground travel.

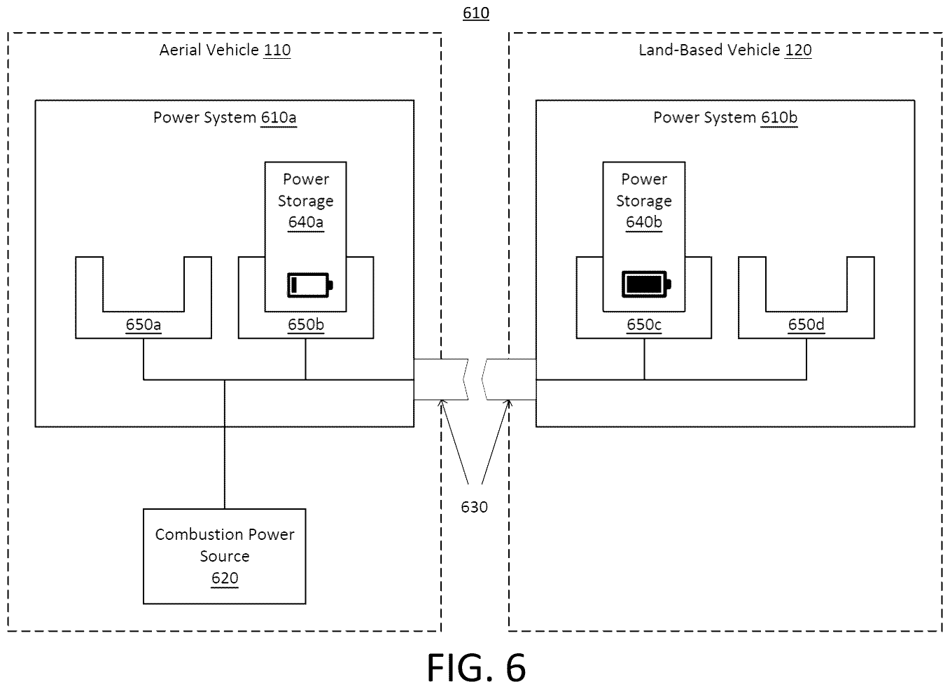

Referring now to FIG. 6, a block diagram of an example power system 610 is illustratively depicted, in accordance with an exemplary embodiment of the present disclosure.

The power system 610 may comprise power components. According to an exemplary embodiment, the power components may be configured to be detachably transferrable between two vehicles (e.g., aerial vehicle 110 and land-based vehicle 120) of a combined multiple vehicle system 100. As illustrated in FIG. 6, the aerial vehicle 110 may comprise a hybrid electric/combustion powered vehicle comprising a power system portion 610a and a combustion power source 620, and the land-based vehicle 120 may comprise an electric powered vehicle including power system portion 610b.

According to an exemplary embodiment, the aerial vehicle 110 may be configured to operates as a mobile charging station for the land-based vehicle 120, providing charging capability via an electrical connection 630. It should be appreciated that electrical connection 630, for providing power, may comprise a wired connection and/or a wireless connection. According to an exemplary embodiment, the land-based vehicle 120 may comprise a hybrid electric/combustion powered vehicle a power system portion 610b and a combustion power source. According to an exemplary embodiment, combustion power source 620 (e.g., for the aerial vehicle 110 and/or the land-based vehicle 120) may comprise an internal combustion engine, a hydrogen fuel cell, and/or another suitable propulsion means other than an electric motor.

According to an exemplary embodiment, the power system 610 of the combined multiple vehicle system 100 may be designed such that connection-free (e.g., wireless) charging may be used between the aerial vehicle 110 and the land-based vehicle 120 to transfer energy to one or more power storage devices (e.g., batteries) of each vehicle at electrical connection 630. For example, the wireless charging may comprise inductive charging between separate coils of each device. According to an exemplary embodiment, one or more vehicle control systems may be configured to determine a relative allocation of energy between the two vehicles based on the intended mission.

According to an exemplary embodiment, the power system 610 of the combined multiple vehicle system 100 may comprise a battery system having power storage components 640a and 640b that may be utilized be each of the two vehicles and that may be detachably transferrable between the two vehicles at connectors 650a-d. According to an exemplary embodiment, power storage components 640a and 640b (e.g., power cells or battery units) may be configured to be transferred between the two vehicles depending on the use case. For example, according to an exemplary embodiment, the power storage components 640a and 640b may be aligned within each vehicle in certain power allocation modes such as, e.g., an in-series mode or a parallel mode. According to an exemplary embodiment, the in-series mode may be configured to provide an extended range to the vehicle (e.g., the aerial vehicle 110 and/or the land-based vehicle 120) and the parallel mode may be configured to provide maximum power to the vehicle. According to an exemplary embodiment, a vehicle control system may be configured to determine the power allocation mode of the vehicle.

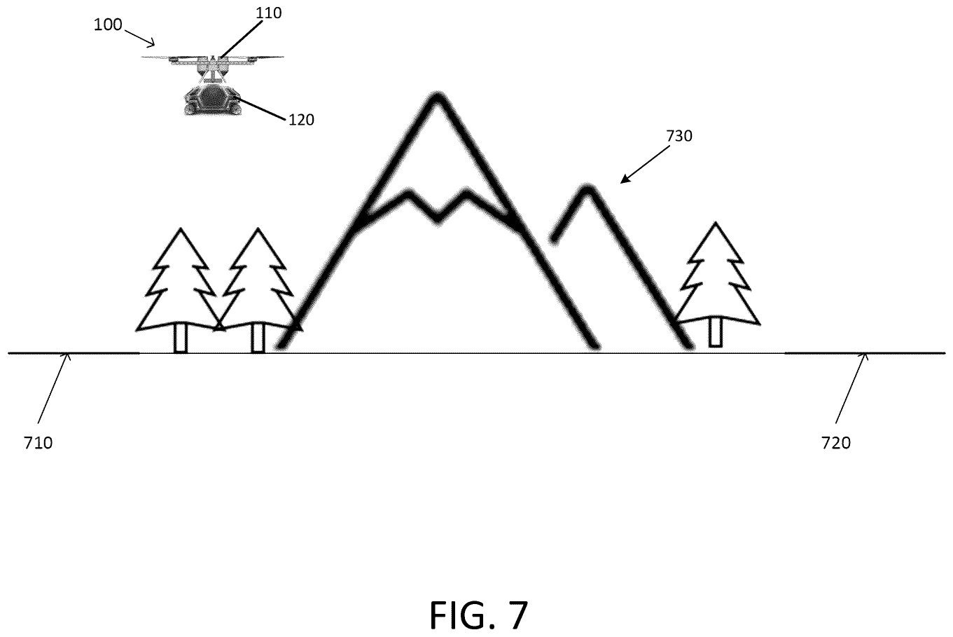

Referring now to FIG. 7, a diagram of a use case of a combination multiple vehicle system 100 comprising an aerial vehicle 110 conveying a land-based vehicle 120 to a destination is illustratively depicted, in accordance with an exemplary embodiment of the present disclosure.

According to an exemplary embodiment, the aerial vehicle 110 may be configured to be removably coupled to the land-based vehicle 120 for conveyance of the land-based vehicle 120 from a first location 710 to a second location 720 for land-based operation. According to an exemplary embodiment, the second location 720 may be inaccessible via ground access from the first location 710 and the second location 720 may be a destination at which ground operations are to be performed by the land-based vehicle 120.

According to an exemplary embodiment, as illustrated in FIG. 7, the second location 720 may be inaccessible via ground access from the first location 710 due to extreme terrain (e.g., mountains and forest 730) between the first location 710 and the second location 720. It should be appreciated that the second location 720 may be inaccessible via ground access from the first location 710 for one or more other reasons, such as, e.g., distance (e.g., travel time is too long for ground access), weather conditions, natural disasters (e.g., forest fires, floods, earthquakes), military conflict, and/or other forms of civil unrest.

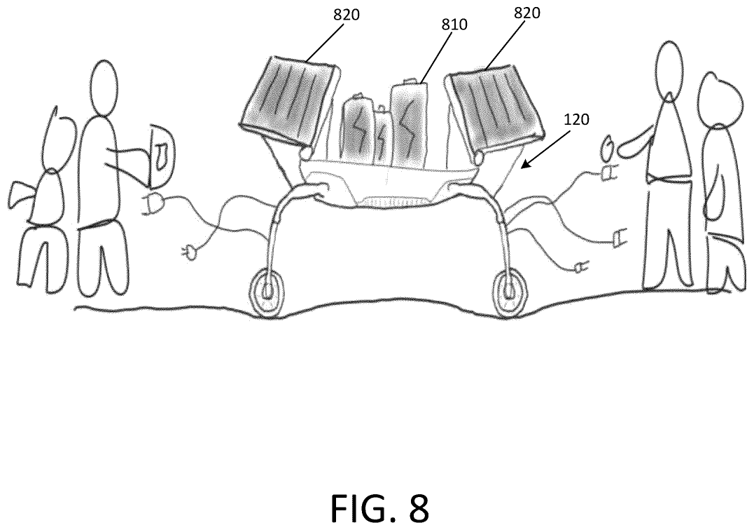

It should be appreciated that various types of ground operations may be performed by the land-based vehicle 120. For instance, FIG. 8 is a diagram illustrating a use case 800 of a land-based vehicle 120 acting as a mobile charging station, in accordance with an exemplary embodiment. A mobile charging station may be configured to provide mobile power to resources located at a destination. For instance, a remote location that is inaccessible or difficult to access over land, such as, e.g., a natural disaster rescue staging site, a refugee camp, a military camp, etc., may require a source of power. According to an exemplary embodiment, the aerial vehicle 110 may be configured to convey a land-based vehicle 120 to the destination. The land-based vehicle 120 may be configured to provide power on-demand to devices at the destination via, e.g., a mobile charging station. According to an exemplary embodiment, the aerial vehicle 110 and/or the land-based vehicle 120 may be configured to operate as a mobile charging station.

According to an exemplary embodiment, the land-based vehicle 120 may comprise a battery 810 configured for storing and/or providing power to one or more connected devices. According to an exemplary embodiment, the aerial vehicle 110 may be configured to charge the battery 810 of the land-based vehicle 120 (e.g., during air travel). According to an exemplary embodiment, the land-based vehicle 120 may comprise one or more solar panels 820 configured to charge the one or more batteries 810.

According to an exemplary embodiment, a power system of the combined multiple vehicle system 100 may be configured and/or designed such that wireless charging may be used between the aerial vehicle 110 and the land-based vehicle 120 to transfer energy to power the one or more storage devices (e.g., batteries 810) of each vehicle. For example, the wireless charging may comprise inductive charging between separate coils of each vehicle. According to an exemplary embodiment, one or more vehicle control systems may be configured to determine a relative allocation of energy between the two vehicles based on an intended mission.

According to an exemplary embodiment, the power system of the combined multiple vehicle system 100 may comprise a battery system comprising one or more power components that may be utilized by each of the two vehicles (the aerial vehicle 110 and the land-based vehicle 120) and which may be detachably transferrable between the two vehicles. According to an exemplary embodiment, these power components, such as, e.g., power cells or battery units, may be configured to be transferred between the two vehicles, depending on the use case. For example, the power components may be aligned within each vehicle in certain power allocation modes such as, e.g., an in-series mode or a parallel mode. According to an exemplary embodiment, the in-series mode may be configured to provide an extended range to the vehicle (e.g., the aerial vehicle 110 and/or the land-based vehicle 120) and the parallel mode may be configured to provide maximum power to the vehicle (e.g., the aerial vehicle 110 and/or the land-based vehicle 120). According to an exemplary embodiment, the vehicle control system may be configured to determine a power allocation mode of the vehicle (e.g., the aerial vehicle 110 and/or the land-based vehicle 120).

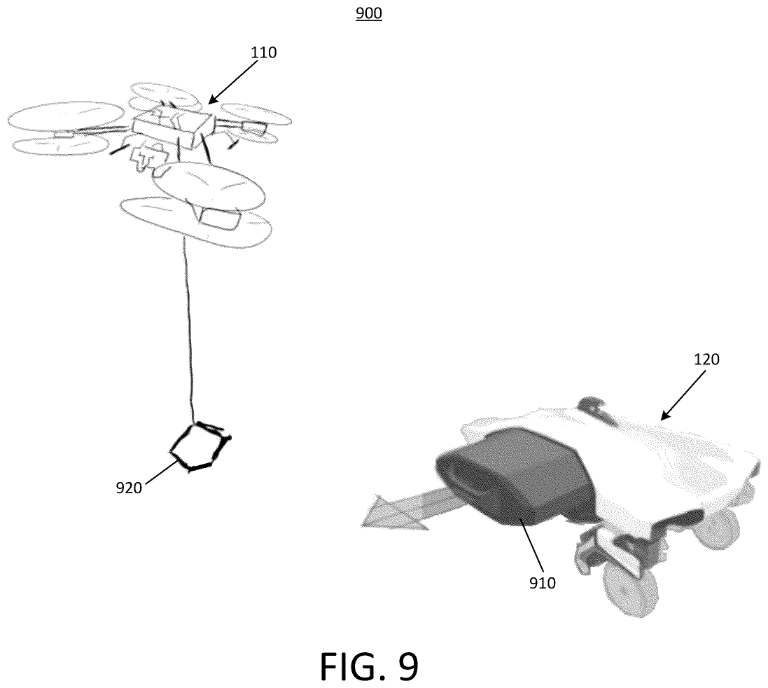

Referring now to FIG. 9, a use case 900 of a combination multiple vehicle system 100 comprising a land-based vehicle 120 comprising a cargo pod 910 is illustratively depicted, in accordance with an exemplary embodiment of the present disclosure.

According to an exemplary embodiment, certain ground-based operations, in which the land-based vehicle 120 may be used, may be for the collection of goods and/or materials. According to an exemplary embodiment, the goods and/or materials may be loaded into the cargo pod 910. According to an exemplary embodiment, the cargo pod 910 may be configured to be removable from the land-based vehicle 120. According to an exemplary embodiment, the land-based vehicle 120 may be configured to transport the cargo pod 910, including any goods and/or materials present.

According to an exemplary embodiment, the aerial vehicle 110 may be configured to retrieve the cargo pod 910 (e.g., using a connection mechanism 920) comprising any collected goods and/or materials and may be configured to deliver the cargo pod 910 to one or more other destinations while the land-based vehicle 120 continues collection. According to an exemplary embodiment, the land-based vehicle 120 may comprise more than one cargo pod 910. According to an exemplary embodiment the aerial vehicle 110 may be configured to deliver another cargo pod 910 to land-based vehicle 120, such that the ground operation may continue while the aerial vehicle 110 transports the first cargo pod 910 to one or more other destinations.

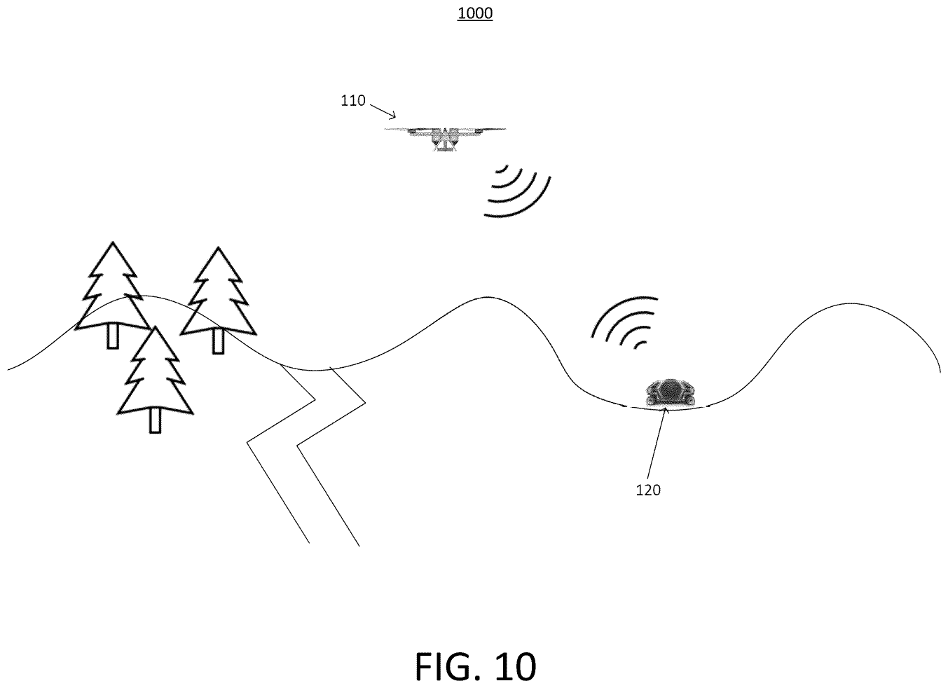

Referring now to FIG. 10, a diagram of a use case 1000 of a combination multiple vehicle system 100 comprising an aerial vehicle 110 surveying terrain and communicating information about the terrain to a land-based vehicle 120 is illustratively depicted, in accordance with an exemplary embodiment of the present disclosure.

According to an exemplary embodiment, the land-based vehicle 120 may be configured to perform one or more ground operations, for example, under autonomous control, and may have incomplete information as to the terrain that must be traveled over. For example, conditions on the ground may not be known due, e.g., to changes to the environment (e.g., natural disasters), weather (e.g., flooding), and/or other suitable factors.

In such use cases, aerial vehicle 110 can scan the terrain and perform mapping of areas of interest (e.g., areas of travel by land-based vehicle 120). Aerial vehicle 110 can transmit the information about the terrain, such as mapping information, to land-based vehicle 120. Land-based vehicle 120 may then use this information in addition to any information it has or is capable of obtaining on its own, to supplement the navigation of land-based vehicle 120 over the terrain. This symbiotic use case of aerial vehicle 110 supplementing the navigation information of land-based vehicle 120 is particularly useful in extreme environments where the terrain may be unknown. For example, this may be particularly useful in exploration of the moon or other planets.

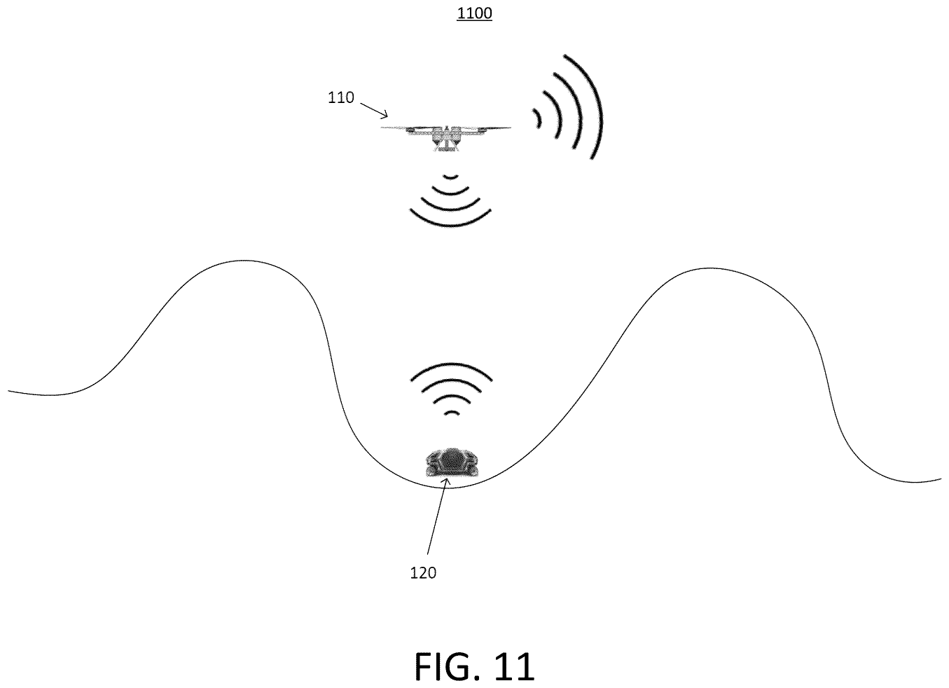

Referring now to FIG. 11, a diagram of a use case 1100 of a combination multiple vehicle system 100 comprising an aerial vehicle 110 and a land-based vehicle 120 operating in combination to provide long-distance communication is illustratively depicted, in accordance with an exemplary embodiment of the present disclosure.

According to an exemplary embodiment, the land-based vehicle 120 may be configured to perform one or more ground operations requiring data communication to a remote location (e.g., a remote command post). Due to the terrain and/or other suitable factors, it may be difficult for the land-based vehicle 120 to maintain a consistent data link between the remote location. For example, according to an exemplary embodiment, the land-based vehicle 120 may traverse a deep canyon with high walls, or otherwise lose a data connection due to natural features between the land-based vehicle 120 and the remote command post.

According to an exemplary embodiment, in such use cases, the aerial vehicle 110 may be configured to hover or fly over the land-based vehicle 120 and act as an intermediary device for supporting data communications between the land-based vehicle 120 and the remote command post. According to an exemplary embodiment, the aerial vehicle 110 may be configured to maintain a location in the air over the land-based vehicle 120, above the natural features that might be blocking or disrupting data communication between the land-based vehicle 120 and the remote command post, thereby improving the data connection between the land-based vehicle 120 and the remote command post. This symbiotic use case of the aerial vehicle 110 supplementing the data communication capabilities of the land-based vehicle 120 is particularly useful in rugged terrain.

According to an exemplary embodiment, the combined multiple vehicle system 100 may comprise one or more other (non)-redundant components configured to facilitate additional use cases and expanded operations, where (non)-redundant refers to a particular component and/or system that may intentionally be duplicated in the two vehicles (e.g., the aerial vehicle 110 and the land-based vehicle 120) to provide a back-up source, or that a single instance of a component or system may be used in one vehicle only. For example, a long-range communication system may be placed in the aerial vehicle 110 to expand a communication range, as illustrated, e.g., in FIG. 11. In another example, one or more energy-intensive tools, such as, e.g., digging tools or drilling tools, with larger energy needs may be placed in the land-based vehicle 120. According to an exemplary embodiment, one or more components and/or systems of the combined multiple vehicle system 100 may be subject to (non)-redundant treatment. In addition to power systems, communication systems, actuated tools, sensing capabilities, and/or computing capabilities may also subject to (non)-redundant system allocation. For example, data may be gathered by one or more sensors by one vehicle but may be subject to computation on the second vehicle (or even a remote, third platform).

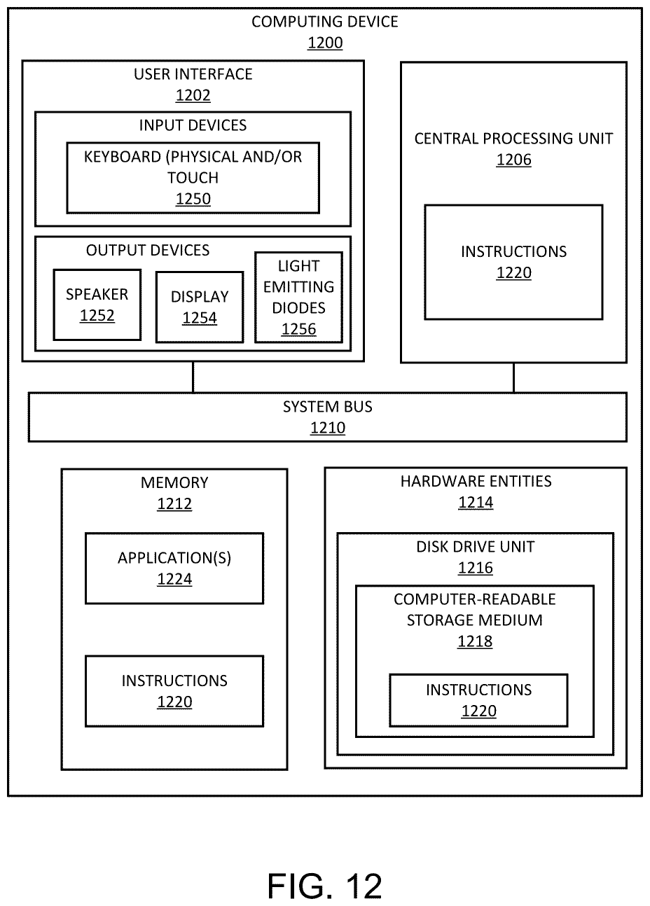

Referring now to FIG. 12, an illustration of an example architecture for a computing device 1200 is provided. According to an exemplary embodiment, one or more functions of the present disclosure may be implemented by a computing device such as, e.g., computing device 1200 or a computing device similar to computing device 1200.

The hardware architecture of FIG. 12 represents one example implementation of a representative computing device configured to perform and/or implement at least a portion of the functions of the system(s) described herein (e.g., combined multiple vehicle system 100, aerial vehicle 110, and/or land-based vehicle 120).

Some or all components of the computing device 1200 may be implemented as hardware, software, and/or a combination of hardware and software. The hardware may comprise, but is not limited to, one or more electronic circuits. The electronic circuits may comprise, but are not limited to, passive components (e.g., resistors and capacitors) and/or active components (e.g., amplifiers and/or microprocessors). The passive and/or active components may be adapted to, arranged to, and/or programmed to perform one or more of the methodologies, procedures, or functions described herein.

As shown in FIG. 12, the computing device 1200 may comprise a user interface 1202, a Central Processing Unit (“CPU”) 1206, a system bus 1210, a memory 1212 connected to and accessible by other portions of computing device 1200 through system bus 1210, and hardware entities 1214 connected to system bus 1210. The user interface may comprise input devices and output devices, which may be configured to facilitate user-software interactions for controlling operations of the computing device 1200. The input devices may comprise, but are not limited to, a physical and/or touch keyboard 1250. The input devices may be connected to the computing device 1200 via a wired or wireless connection (e.g., a Bluetooth® connection). The output devices may comprise, but are not limited to, a speaker 1252, a display 1254, and/or light emitting diodes 1256.

At least some of the hardware entities 1214 may be configured to perform actions involving access to and use of memory 1212, which may be a Random Access Memory (RAM), a disk driver and/or a Compact Disc Read Only Memory (CD-ROM), among other suitable memory types. Hardware entities 1214 may comprise a disk drive unit 1216 comprising a computer-readable storage medium 1218 on which may be stored one or more sets of instructions 1220 (e.g., programming instructions such as, but not limited to, software code) configured to implement one or more of the methodologies, procedures, or functions described herein. The instructions 1220 may also reside, completely or at least partially, within the memory 1212 and/or within the CPU 1206 during execution thereof by the computing device 1200.

The memory 1212 and the CPU 1206 may also constitute machine-readable media. The term “machine-readable media”, as used here, refers to a single medium or multiple media (e.g., a centralized or distributed database, and/or associated caches and servers) that store the one or more sets of instructions 1220. The term “machine-readable media”, as used here, also refers to any medium that is capable of storing, encoding or carrying a set of instructions 1220 for execution by the computing device 1200 and that cause the computing device 1200 to perform any one or more of the methodologies of the present disclosure.

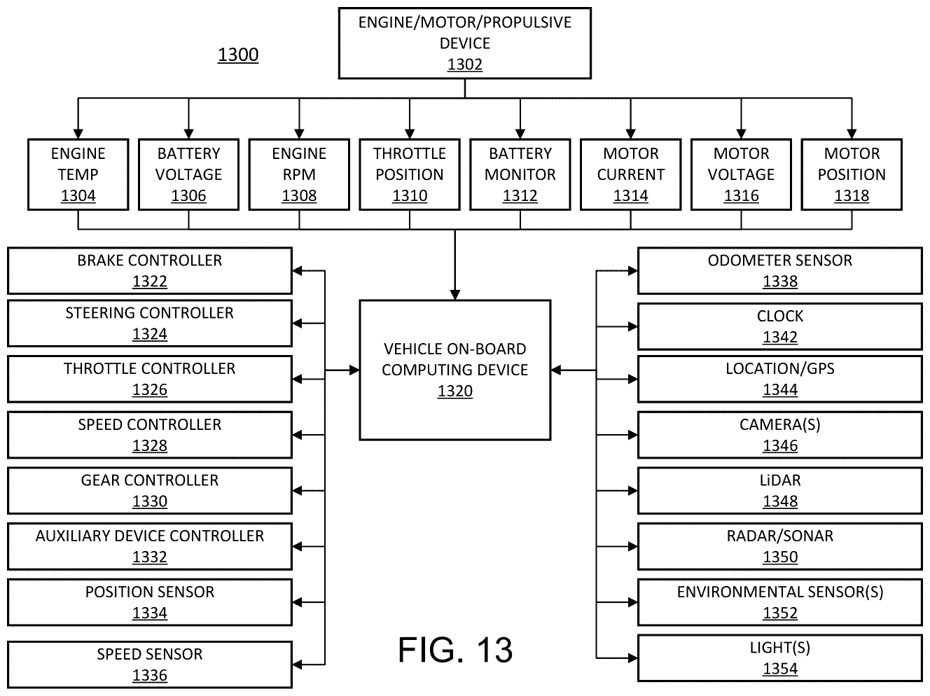

Referring now to FIG. 13, an example vehicle system architecture 1300 for a vehicle is provided, in accordance with an exemplary embodiment of the present disclosure.

The combined multiple vehicle system 100, the aerial vehicle 110, and/or the land-based vehicle 120 may be configured to be incorporated in or with a vehicle having the same or similar system architecture as that shown in FIG. 13. Thus, the following discussion of vehicle system architecture 1300 is sufficient for understanding one or more components of the combined multiple vehicle system 100, the aerial vehicle 110, and/or the land-based vehicle 120.

As shown in FIG. 13, the vehicle system architecture 1300 may comprise an engine, motor or propulsive device (e.g., a thruster) 1302 and various sensors 1304-1318 for measuring various parameters of the vehicle system architecture 1300. In gas-powered or hybrid vehicles having a fuel-powered engine, the sensors 1304-1318 may comprise, for example, an engine temperature sensor 1304, a battery voltage sensor 1306, an engine revolutions per minute (RPM) sensor 1308, and/or a throttle position sensor 1310. If the vehicle is an electric or hybrid vehicle, then the vehicle may comprise an electric motor, and accordingly may comprise sensors such as a battery monitoring system 1312 (to measure current, voltage and/or temperature of the battery), motor current 1314 and voltage 1316 sensors, and motor position sensors such as resolvers and encoders 1318.

Operational parameter sensors that are common to both types of vehicles may comprise, for example: a position sensor 1334 such as an accelerometer, gyroscope and/or inertial measurement unit; a speed sensor 1336; and/or an odometer sensor 1338. The vehicle system architecture 1300 also may comprise a clock 1342 that the system uses to determine vehicle time and/or date during operation. The clock 1342 may be encoded into the vehicle on-board computing device 1320, it may be a separate device, or multiple clocks may be available.

The vehicle system architecture 1300 also may comprise various sensors that operate to gather information about the environment in which the vehicle is traveling. These sensors may comprise, for example: a location sensor 1344 (for example, a Global Positioning System (GPS) device); object detection sensors such as one or more cameras 1346; a LiDAR sensor system 1348; and/or a RADAR and/or a sonar system 1350. The sensors also may comprise environmental sensors 1352 such as, e.g., a humidity sensor, a precipitation sensor, a light sensor, and/or ambient temperature sensor. The object detection sensors may be configured to enable the vehicle system architecture 1300 to detect objects that are within a given distance range of the vehicle in any direction, while the environmental sensors 1352 may be configured to collect data about environmental conditions within the vehicle's area of travel. According to an exemplary embodiment, the vehicle system architecture 1300 may comprise one or more lights 1354 (e.g., headlights, flood lights, flashlights, etc.).

During operations, information may be communicated from the sensors to an on-board computing device 1320 (e.g., computing device 1200 of FIG. 12). The on-board computing device 1320 may be configured to analyze the data captured by the sensors and/or data received from data providers and may be configured to optionally control operations of the vehicle system architecture 1300 based on results of the analysis. For example, the on-board computing device 1320 may be configured to control: braking via a brake controller 1322; direction via a steering controller 1324; speed and acceleration via a throttle controller 1326 (in a gas-powered vehicle) or a motor speed controller 1328 (such as a current level controller in an electric vehicle); a differential gear controller 1330 (in vehicles with transmissions); and/or other controllers. The brake controller 1322 may comprise a pedal effort sensor, pedal effort sensor, and/or simulator temperature sensor, as described herein.

Geographic location information may be communicated from the location sensor 1344 to the on-board computing device 1320, which may then access a map of the environment that corresponds to the location information to determine known fixed features of the environment such as streets, buildings, stop signs and/or stop/go signals. Captured images from the cameras 1346 and/or object detection information captured from sensors such as LiDAR 1348 may be communicated from those sensors to the on-board computing device 1320. The object detection information and/or captured images may be processed by the on-board computing device 1320 to detect objects in proximity to the vehicle. Any known or to be known technique for making an object detection based on sensor data and/or captured images may be used in the embodiments disclosed in this document.

What has been described above includes examples of the subject disclosure. It is, of course, not possible to describe every conceivable combination of components or methodologies for purposes of describing the subject matter, but it is to be appreciated that many further combinations and permutations of the subject disclosure are possible. Accordingly, the claimed subject matter is intended to embrace all such alterations, modifications, and variations that fall within the spirit and scope of the appended claims.

In particular and in regard to the various functions performed by the above described components, devices, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the claimed subject matter.

The aforementioned systems and components have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components may be combined into a single component providing aggregate functionality or divided into several separate sub-components. Any components described herein may also interact with one or more other components not specifically described herein.

In addition, while a particular feature of the subject innovation may have been disclosed with respect to only one of several implementations, such feature may be combined with one or more other features of the other implementations as may be desired and advantageous for any given or particular application. Furthermore, to the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

Thus, the embodiments and examples set forth herein were presented in order to best explain various selected embodiments of the present invention and its particular application and to thereby enable those skilled in the art to make and use embodiments of the invention. However, those skilled in the art will recognize that the foregoing description and examples have been presented for the purposes of illustration and example only. The description as set forth is not intended to be exhaustive or to limit the embodiments of the invention to the precise form disclosed.

What is claimed is:

1. A multiple vehicle system comprising:
a land-based vehicle configured to traverse over ground;
an aerial vehicle configured to travel through air; and
a power system comprising a plurality of power components, wherein the plurality of power components are distributed across the land-based vehicle and the aerial vehicle,
wherein the aerial vehicle is configured to detachably couple with the land-based vehicle.

2. The multiple vehicle system of claim 1, wherein the land-based vehicle and the aerial vehicle are electrically coupled via an electrical connection.

3. The multiple vehicle system of claim 2, wherein the electrical connection comprises a wireless connection.

4. The multiple vehicle system of claim 3, wherein the electrical connection is configured to provide power transmission between the land-based vehicle and the aerial vehicle.

5. The multiple vehicle system of claim 4, wherein:
the plurality of power components comprises one or more batteries, and
the power transmission is configured to charge a battery of the plurality of power components.

6. The multiple vehicle system of claim 5, wherein the power transmission is configured to transmit power from the aerial vehicle to a battery of the land-based vehicle.

7. The multiple vehicle system of claim 5, wherein the power transmission is configured to transmit power from the land-based vehicle to a battery of the aerial vehicle.

8. The multiple vehicle system of claim 1, wherein at least one power component of the plurality of power components is detachably transferrable between the land-based vehicle and the aerial vehicle.

9. The multiple vehicle system of claim 1, wherein the plurality of power components is configured to be utilized in series at one of the land-based vehicle and the aerial vehicle.

10. The multiple vehicle system of claim 1, wherein the plurality of power components is configured to be utilized in parallel at one of the land-based vehicle and the aerial vehicle.

11. A system comprising:
a multiple vehicle system comprising:
a land-based vehicle configured to traverse over ground;
an aerial vehicle configured to travel through air; and
a power system comprising a plurality of power components, wherein the plurality of power components are distributed across the land-based vehicle and the aerial vehicle,
wherein the aerial vehicle is configured to detachably couple with the land-based vehicle; and
a computing device, comprising a processor and a memory, configured to store programming instructions that, when executed by the processor, cause the processor to:
cause the aerial vehicle to detach from the land-based vehicle.

12. The system of claim 11, wherein the land-based vehicle and the aerial vehicle are electrically coupled via an electrical connection.

13. The system of claim 12, wherein the electrical connection comprises a wireless connection.

14. The system of claim 13, wherein the electrical connection is configured to provide power transmission between the land-based vehicle and the aerial vehicle.

15. The system of claim 14, wherein:
the plurality of power components comprises one or more batteries, and
the power transmission is configured to charge a battery of the plurality of power components.

16. The system of claim 15, wherein the power transmission is configured to transmit power from the aerial vehicle to a battery of the land-based vehicle.

17. The system of claim 15, wherein the power transmission is configured to transmit power from the land-based vehicle to a battery of the aerial vehicle.

18. The system of claim 11, wherein at least one power component of the plurality of power components is detachably transferrable between the land-based vehicle and the aerial vehicle.

19. The system of claim 11, wherein the plurality of power components is configured to be utilized in series at one of the land-based vehicle and the aerial vehicle.

20. The system of claim 11, wherein the plurality of power components is configured to be utilized in parallel at one of the land-based vehicle and the aerial vehicle.
